(19) United States
(12) Patent Application Publication
(10) Pub. No.: US 2014/0001142 A1
(43) Pub. Date: Jan. 2, 2014

(54) Nursing bottle with temperature indicator

(71) Applicant: Chris Wu, City of Industry, CA (US)

(72) Inventor: Chris Wu, City of Industry, CA (US)

(21) Appl. No.: 13/534,026

(22) Filed: Jun. 27, 2012

(51) Int. Cl. A61J 9/02

(52) U.S. Cl. 215/11.2

(57) ABSTRACT

A nursing bottle includes a bottle, a sealing unit detachably coupled at a top opening of the bottle to seal a nipple thereat, and a temperature indicator extended from the sealing unit into an interior of the bottle, wherein the temperature indicator is suspended and supported the said bottle in abutting relation to an interior wall of a neck portion of a surrounding wall of the bottle for indicating an interior temperature of the bottle.

### BACKGROUND

1. Field of the Invention

The present invention relates to a nursing bottle. More particularly, the present invention relates to a nursing bottle with a temperature indicator for visibly indicating the interior temperature of the nursing bottle.

2. Discussion of the Related Art

Generally, breast milk or infant formula (artificial milk) is designed for feeding babies and infants under 12 months of age. Most working mothers would like to keep their breast milk in the refrigerator and then warm the refrigerated breast milk when they feed their babies. For preparing infant formula, boiled water is poured into a nursing bottle before the proper amount of powdered formula is then added to the bottle of water. The bottle is shaken gently until the powdered formula is dissolved and well mixed into the water.

No matter what kind of milk being used for feeding the baby, it is necessary to keep the milk at a proper temperature. If the milk is too hot, the baby can be burnt. If the milk is too cold, the baby can suffer from a laxity of bowels. Most mothers will determine the milk temperature by sensuous method. They will either touch the nursing bottle by hand or simply release few drops of milk in the nursing bottle to the hand. However, such method is not reliable to determine the temperature of milk in the nursing bottle. Another method for determining the milk temperature is to use a thermometer, wherein mothers may repeatedly place the thermometer in the nursing bottle to measure the milk temperature until the milk is cooled down at an optimum temperature. However, most mothers feel infuriated to keep measuring the milk temperature by the thermometer at the mean time they have to take care of their babies.

A proposed nursing bottle includes a thermometer extended into the interior of the nursing bottle. However, the thermometer is located at the center of the nursing bottle so that the reading portion of the thermometer is submerged within the milk to block the reading scale at the thermometer. Specifically, the reading scale of the thermometer is too small to read.

Another proposed nursing bottle includes a built-in thermometer at the exterior wall of the nursing bottle. However, the built-in thermometer is unreliable that the built-in thermometer can only read the exterior surface of the nursing bottle and the reading of the built-in thermometer will be significantly affected by the ambient temperature.

Therefore, a need exists for a temperature measurer for the nursing bottle to accurately measure the interior temperature of the nursing bottle and to enable the mothers to read the temperature measurement easily.

### BRIEF SUMMARY OF THE INVENTION

The present invention overcomes the above mentioned drawbacks and limitation by incorporating a temperature indicator with a nursing bottle for indicating the interior temperature of the contents of the nursing bottle which obviates the aforementioned disadvantages of the conventional arts.

The primary objective of the present invention is that the temperature indicator is a non-electronic and battery-less temperature indicator, wherein no electronic circuit is employed in the present invention to lower the manufacturing cost and to prevent a malfunction of the temperature indicator.

Another objective of the present invention is that the temperature indicator is supported in the nursing bottle in abutting relation to an interior side of the neck portion of the surrounding wall which facilitates observation.

Another objective of the present invention is that the temperature indicator is readily available, disposable and inexpensive.

Another objective of the present invention is that the temperature indicator carries a mark, such as a happy face, of medium changing color at a desired temperature to indicate the interior temperature of the nursing bottle.

Another objective of the present invention is that the temperature indicator which does not interfere or obstruct the flow of fluid from the nursing bottle during feeding operation.

Another objective of the present invention is that the temperature indicator is compatible with any nursing bottle having a sealing ring.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a nursing bottle with a temperature indicator in accordance with the present invention.

FIG. 2 is a sectional view of the nursing bottle in accordance with the present invention, showing the temperature indicator supported in the nursing bottle in abutting relation to an interior wall of the neck portion of the surrounding wall.

FIG. 3 shows a changing mark of the temperature indicator in response to the interior temperature of the nursing bottle in accordance with the present invention.

FIG. 4 shows a modification of the temperature indicator of the nursing bottle in accordance with the present invention.

### DETAILED DESCRIPTION OF THE INVENTION

Examples according to the present invention will be explained with reference to the drawings.

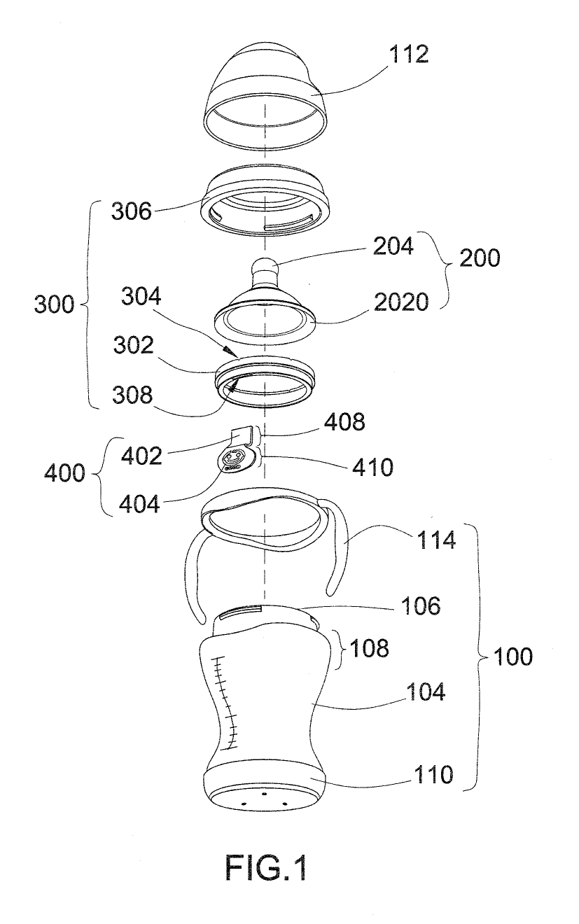

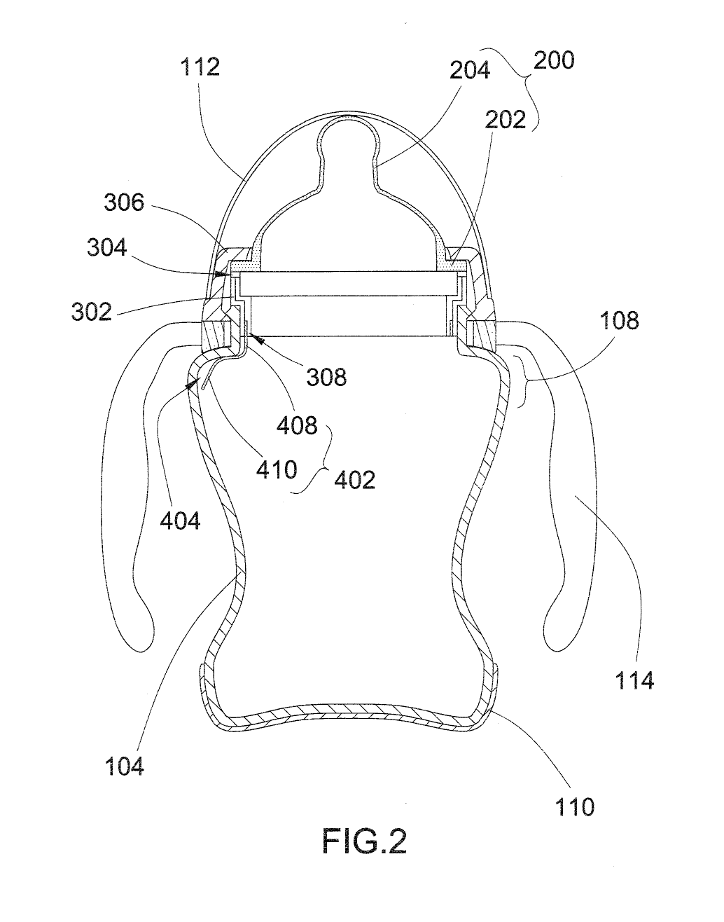

In accordance with a preferred embodiment of the present invention, the present invention provides a nursing bottle for containing fluid such as milk or water therein. In FIGS. 1 and 2, the nursing bottle comprises a bottle 100, a nipple 200, a sealing unit 300, and a temperature indicator 400.

The bottle 100 generally is a cylindrical container comprising a bottom 102 and a surrounding wall 104 upwardly extended from the bottom 102, wherein a top opening 106 is defined at a neck portion 108 of the surrounding wail 104. The bottle 100 may be formed of any suitable material such as glass, plastic or rubber. An antiskid sleeve 110 is provided at the bottom 102 of the bottle 100 for preventing the bottle 100 being skidded at any surface. A scale is also provided at the surrounding wall 104 of the bottle 100 to show the volume of fluid contained in the bottle 100. A cap 112 is detachably coupled with the bottle 100 to enclose the nipple 200. A handle 114 is further provided to detachably couple with the bottle 100.

The nipple 200 is placed at the top opening 106 of the bottle 100. The nipple 200 is a feeding nipple according to the present invention, which is designed to fit any commercially available nursing bottle. The nipple 200 generally comprises a sealing disc 202 being placed and sealed around the top opening 106 of the bottle 100 and a perforated mouthpiece 204 upwardly extended from the sealing disc 202.

The sealing unit 300 is detachably coupled at the top opening 106 of the bottle 100 to seal the nipple 200 thereat. The sealing unit 300 comprises a sealing ring 302 detachably coupled with the bottle 100 to seal the sealing disc 202 of the nipple 200 at the top opening 106 of the bottle 100.

The sealing ring 302 has a bottom portion 310 fitting within the top opening 106 of the bottle 100 and an upper portion 312 resting on the top opening 106 of the bottle 100. In this embodiment, the sealing ring 302 is an air vent sealing ring for air ventilation during feeding operation. The sealing ring 302 has a plurality of venting slits 304 provided at a top edge of the sealing ring 302 for air ventilation during feeding. When the bottle 100 is positioned at a tilted position or inverted position for feeding, ambient air can enter into the bottle 100 through the venting slits 304 at the time the suction effect is created in the bottle 100.

The sealing unit 300 further comprises an annular member 306 detachably coupled at the top opening 106 of the bottle 100, wherein the sealing ring 302 is encircled within the annular member 306 so that the sealing disc 202 of the nipple 200 is sealed and held between the outer side of the sealing ring 302 and the inner side of the annular member 306.

In FIGS. 1 and 2, the temperature indicator 400 is extended from the sealing unit 300 into the interior of the bottle 100, wherein the temperature indicator 400 is suspended and supported within the bottle 100 in abutting relation to an interior side of the neck portion 108 of the surrounding wail 104 for indicating an interior temperature of the bottle 100.

In this embodiment, the temperature indicator 400 comprises a suspending member 402 extended from the sealing unit 300 and a temperature sensitive element 404 provided at the suspending member 402, wherein the temperature sensitive element 404 configured to be a mark of medium changing color at a desired temperature for indicating the interior temperature of the bottle 100. It is preferred that the temperature sensitive element 404 is in form of thermochromatic ink.

The temperature indicator 400 further comprises a transparent protective enclosure 406 to the temperature sensitive element 404. It is preferred that the transparent protective enclosure 406 seals and encloses the suspending member 402 with the temperature sensitive element 404 therewitin to prevent the temperature sensitive element 404 directly contacting with the liquid in the bottle 100. Therefore, the protective enclosure 406 is an isolated sleeve to seal and enclose the temperature sensitive element 404.

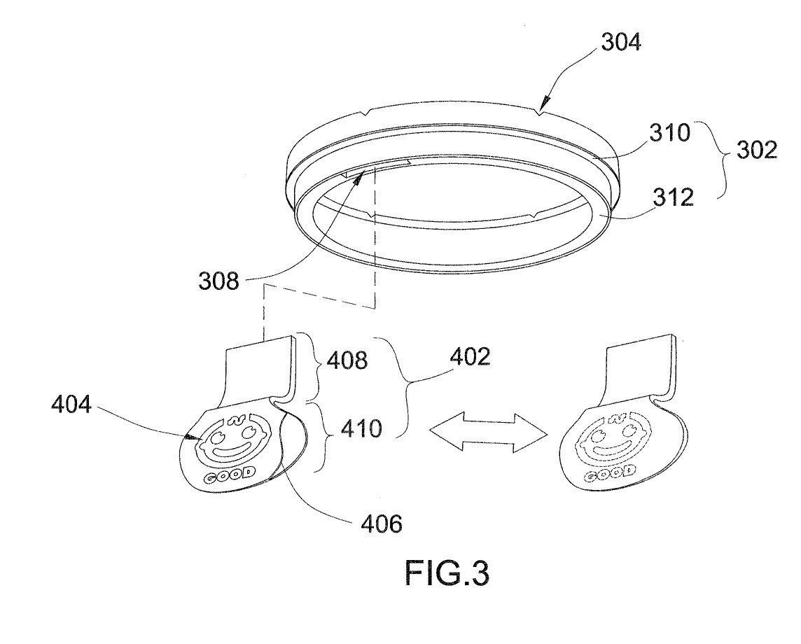

In FIG. 3, the temperature indicator 400 is detachably coupled with the sealing ring 302 of the sealing unit 300. In this embodiment, the sealing ring 302 has a holding slot 308 provided at a bottom edge of the sealing ring 302, wherein a top edge portion of the suspending member 402 is detachably inserted into the holding slot 308 so that the temperature indicator 400 is suspended within the bottle 100 and located close to the interior side of the neck portion 108 of the surrounding wall 104 of the bottle 100. In FIG. 3, the top edge portion of the suspending member 402 has a rectangular shape to retain the suspending member 402 below the sealing ring 302 when the top edge portion of the suspending member 402 is inserted into the holding slot 306.

For ensuring the location of the temperature indicator 400, the suspending member 402 has an outward curving portion 408 extended from the sealing ring 302 and an enlarged display portion 410 where the temperature sensitive element 404 provided thereat, wherein the display portion 410 is downwardly extended from the outward curving portion 408 to ensure the display portion 410 being laid at the interior side of the bottle 100 at the neck portion 108 thereof.

In this embodiment, the outward curving portion 408 of the suspending member 402 ensures the display portion 410 being located close to the interior side of the bottle 100. When the sealing ring 302 is turned to detachably couple at the top opening 106 of the bottle 100, the display portion 410 will always be located close to the interior side of the bottle 100. The display portion 410 of the suspending member 400 has an enlarged surface that the mark of the temperature sensitive element 404 is provided thereat.

In FIG. 3, the mark of the temperature sensitive element 404 will change color when the interior temperature of the bottle 100 increases or decreases. The mark of the temperature sensitive element 404 may turn transparent when interior temperature of the bottle 100 changes. In this embodiment, the mark of temperature sensitive element 404 is configured to have a “blue happy face” mark, wherein when the interior temperature of the bottle 100 is lukewarm (suitable for feeding), the mark of temperature sensitive element 404 will be in blue color and “happy face” mark will be visible. When the interior temperature of the bottle 100 is hot (not suitable for feeding), the mark of temperature sensitive element 404, i.e. the “happy face” mark, will be invisible or disappeared. Therefore, once the mark is visible, the fluid contained in the bottle 100 is suitable for feeding the baby.

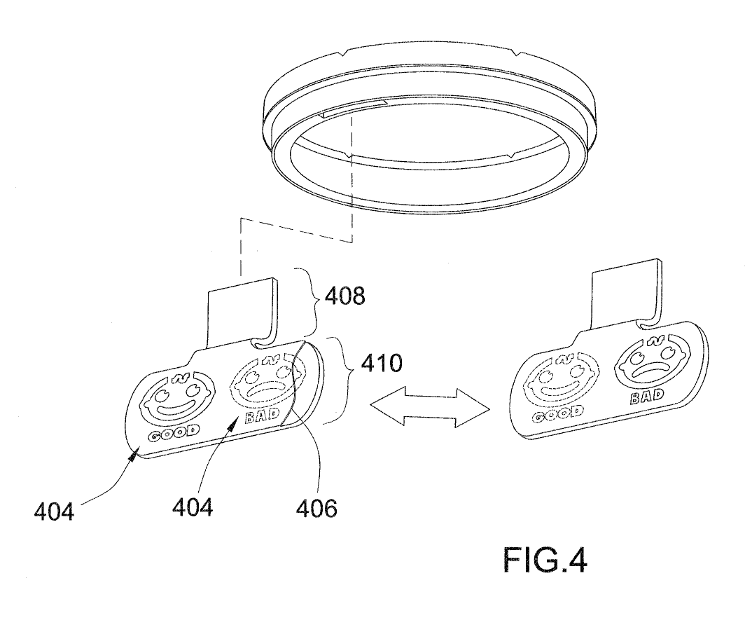

FIG. 4 shows a modification of the mark of temperature sensitive element 404, wherein two different marks are provided at the display portion 410 of the suspending member 402 side by side. One of the marks is a “lukewarm” mark to indicate the interior temperature of the bottle 100 is suitable for feeding and another mark is a “hot” mark to indicate the interior temperature of the bottle 100 is unsuitable for feeding. The “lukewarm” mark is configured to be a “ blue happy face” mark and the “hot” mark is configured to be a “red sad face” mark.

When the interior temperature of the bottle 100 is lukewarm (suitable for feeding), the “lukewarm” mark will visible whereas the “hot” mark will be disappeared. When the interior temperature of the bottle 100 is hot (not suitable for feeding), the “lukewarm” mark will invisible whereas the “hot” mark will be invisible.

The mark of temperature sensitive element 404 makes it possible to indicate the interior temperature of the bottle 100 at the desired feeding temperature, preferably 98.6 F, wherein the mark of temperature sensitive element 404 quickly shows the liquid within the bottle 100 either too hot or too cold.

It is understood that the embodiment of the invention herein described and illustrated is exemplary only and is not intended in any manner to limit the scope of this invention which is to be limited only by the appended claims.

What is claimed is:

1. A nursing bottle, comprising
a bottle comprising a bottom and a surrounding wall, and defining a top opening at a neck portion of said surrounding wall;
a nipple being placed at said top opening of said bottle;
a sealing unit detachably coupled at said top opening of said bottle to seal said nipple thereat; and
a temperature indicator extended from said sealing unit into an interior of said bottle, wherein said temperature indicator is suspended and supported within said bottle in abutting relation to an interior side of said neck portion of said surrounding wall for indicating an interior temperature of said bottle.

2. The nursing bottle of claim 1 wherein said temperature indicator comprises a suspending member extended from said sealing unit and a temperature sensitive element provided at said suspending member, wherein said temperature sensitive element configured to be a mark of medium changing color at a desired temperature for indicating said interior temperature of said bottle.

3. The nursing bottle of claim 2 wherein said temperature indicator comprises a transparent protective enclosure sealing said suspending member with said temperature sensitive element therewitin.

4. The nursing bottle of claim 1 wherein said temperature indicator is detachably attached to said sealing unit.

5. The nursing bottle of claim 3 wherein said temperature indicator is detachably attached to said sealing unit.

6. The nursing bottle of claim 1 wherein said sealing unit comprises a sealing ring detachably coupled at said top opening of said bottle, wherein said temperature indicator extended from said sealing ring into said interior of said bottle.

7. The nursing bottle of claim 2 wherein said sealing unit comprises a sealing ring detachably coupled at said top opening of said bottle, wherein said temperature indicator extended from said sealing ring into said interior of said bottle.

8. The nursing bottle of claim 3 wherein said sealing unit comprises a sealing ring detachably coupled at said top opening of said bottle, wherein said temperature indicator extended from said sealing ring into said interior of said bottle.

9. The nursing bottle of claim 7 wherein said sealing ring has a holding slot provided at a bottom edge of said sealing ring, wherein a top edge portion of said suspending member is detachably inserted into said holding slot so that said temperature indicator is suspended within said bottle and located close to said interior side of said neck portion of said surrounding wall.

10. The nursing bottle of claim 8 wherein said sealing ring has a holding slot provided at a bottom edge of said sealing ring, wherein a top edge portion of said suspending member is detachably inserted into said holding slot so that said temperature indicator is suspended within said bottle and located close to said interior side of said neck portion of said surrounding wall.

11. The nursing bottle of claim 8 wherein said suspending member has an outward curving portion extended from said sealing ring and an enlarged display portion where said temperature sensitive element provided thereat, wherein said display portion is downwardly extended from said outward curving portion to ensure said display portion being laid at said interior side of said bottle at said neck portion thereof.

12. The nursing bottle of claim 10 wherein said suspending member has an outward curving portion extended from said sealing ring and an enlarged display portion where said temperature sensitive element provided thereat, wherein said display portion is downwardly extended from said outward curving portion to ensure said display portion being laid at said interior side of said bottle at said neck portion thereof.

13. The nursing bottle of claim 8 wherein said sealing ring further has a plurality of venting slits provided at a top edge of said sealing ring for air ventilation during feeding.

14. The nursing bottle of claim 10 wherein said sealing ring further has a plurality of venting slits provided at a top edge of said sealing ring for air ventilation during feeding.

15. The nursing bottle of claim 12 wherein said sealing ring further has a plurality of venting slits provided at a top edge of said sealing ring for air ventilation during feeding.

16. A nursing bottle, comprising
a bottle comprising a bottom and a surrounding wall, and defining a top opening at a neck portion of said surrounding wall;
a sealing ring detachably coupled at said top opening of said bottle for sealing a nipple thereat; and
a temperature indicator, which is a non-electronic temperature indicator, extended from said sealing ring into an interior of said bottle, wherein said temperature indicator is suspended and supported within said bottle in abutting relation to an interior side of said neck portion of said surrounding wall for indicating an interior temperature of said bottle and for being observed easily.

17. The nursing bottle of claim 16 wherein said temperature indicator comprises a temperature sensitive element carrying a mark of medium changing color at a desired temperature for indicating said interior temperature of said bottle.

18. The nursing bottle of claim 17 wherein said temperature indicator further comprises a suspending member having an outward curving portion extended from said sealing ring and an enlarged display portion where said temperature sensitive element provided thereat, wherein said display portion is downwardly extended from said outward curving portion to ensure said display portion being laid at said interior wall of said bottle at said neck portion thereof.

19. The nursing bottle of claim 16 wherein said sealing ring is an air vent sealing ring having a plurality of venting slits provided at a top edge of said sealing ring for air ventilation during feeding.

20. The nursing bottle of claim 16 wherein said sealing ring has a holding slot provided at a bottom edge of said sealing ring, wherein a top edge of said temperature indicator is detachably inserted into said holding slot so that said temperature indicator is suspended within said bottle and located close to said interior side of said neck portion of said surrounding wall.
